(19) United States
(12) Patent Application Publication
(10) Pub. No.: US 2025/0208909 A1
(43) Pub. Date: Jun. 26, 2025

(54) ACTIONS APPLICATION PROGRAMMING INTERFACE FOR WIRELESS NETWORK CONFIGURATION

(71) Applicant: AT&T Intellectual Property I, L.P., Atlanta, GA (US)

(72) Inventors: Ioannis Broustis, Basking Ridge, NJ (US); Kevin Smokowski, Freehold, NJ (US); Rajesh Panta, Bridgewater, NJ (US)

(21) Appl. No.: 18/395,464

(22) Filed: Dec. 22, 2023

(51) Int. Cl. G06F 9/48

(52) U.S. Cl. CPC G06F 9/4881

(57) ABSTRACT

A processing system may obtain, from a requesting system, a request for a network management task associated with at least one managed object in the communication network. The at least one managed object may be of a first vendor of a plurality of vendors. In addition, the processing system may comprise an application programming interface to process network management task requests associated with managed objects of a plurality of different vendors. The processing system may next select a pipeline of functions associated with the network management task, where the pipeline of functions is specific to the first vendor and to the network management task, gather network state information relating to the pipeline of functions, and execute the pipeline of functions based upon the network state information to perform the network management task. The processing system may then report to the requesting system a result of the network management task.

The present disclosure relates generally to communication network operations, and more specifically to methods, computer-readable media, and apparatuses for selecting and executing a pipeline of functions specific to a first vendor and to a network management task based upon network state information.

### BACKGROUND

In data communication networks, efficient management and utilization of network resources may be challenging due exponential growth in network demand, driven in part by technology advancements with fiber rollouts, 5G wireless service expansion, increasing deployment of Internet of things (IoT) devices and systems, and so forth, along with supply chain or other inventory-side issues, as well as the heterogeneous nature of network components and the particularities of different vendors' systems. As such, present techniques for capacity planning, allocation, and utilization may be sub-optimal.

### SUMMARY

The present disclosure describes methods, computer-readable media, and apparatuses for selecting and executing a pipeline of functions specific to a first vendor and to a network management task based upon network state information. For instance, in one example, a processing system including at least one processor deployed in a communication network may obtain, from a requesting system, a request for a network management task associated with at least one managed object in the communication network. The at least one managed object may be of a first vendor of a plurality of vendors. In addition, the processing system may comprise an application programming interface to process network management task requests associated with managed objects of a plurality of different vendors including the first vendor. The processing system may next select a pipeline of functions associated with the network management task, where the pipeline of functions is specific to the first vendor and to the network management task, gather network state information relating to the pipeline of functions, and execute the pipeline of functions based upon the network state information to perform the network management task. The processing system may then report to the requesting system a result of the network management task.

### BRIEF DESCRIPTION OF THE DRAWINGS

The present disclosure can be readily understood by considering the following detailed description in conjunction with the accompanying drawings, in which:

FIG. 1 illustrates an example of a system related to the present disclosure;

FIG. 2 illustrates an example action application programming interface controller, in accordance with the present disclosure;

FIG. 3 illustrates an example format of an actions application programming interface request, in accordance with the present disclosure;

FIG. 4 illustrates an example format of an actions application programming interface response, in accordance with the present disclosure;

FIG. 5 illustrates an example flowchart of a method for selecting and executing a pipeline of functions specific to a first vendor and to a network management task based upon network state information; and

FIG. 6 illustrates a high-level block diagram of a computing device specially programmed to perform the functions described herein.

To facilitate understanding, identical reference numerals have been used, where possible, to designate identical elements that are common to the figures.

### DETAILED DESCRIPTION

The present disclosure broadly discloses methods, non-transitory (i.e., tangible or physical) computer-readable media, and apparatuses for selecting and executing a pipeline of functions specific to a first vendor and to a network management task based upon network state information. In particular, automation applications for communication network management can be complex in terms of both design logic as well as actual implementation. Due to individualized designs, these applications may impose their own specific requirements regarding the actions that need to be applied to network elements. Such actions may range from very simple operations (e.g., “read the value of a parameter”) to highly complex ones (e.g., “configure all the parameters specific to a feature, by considering the states of all the other network elements on the same node”). Thus, implementation and maintenance of such logic may be tedious and error prone. This is especially the case considering that the volume of such applications continues to increase.

Examples of the present disclosure provide a comprehensive action framework that is able to accommodate all such actions/task using predefined pipelines that are made available in a catalog, such that all applications can leverage these pipelines for various purposes. In particular, a larger communication network may include network elements from various vendors. In addition, the communication network may include multiple network management systems (NMSs) (e.g., one or more for each vendor), which expose northbound application programming interfaces (APIs) providing machine-to-machine (M2M) connectivity. However, these APIs may be vendor-dependent and may provide for only atomic operations. For instance, the APIs may provide for the concepts of “read” or “write” between a client and NMS, without any relationship between such actions/tasks. As a result, applications using a NMS to access a network element (e.g., a managed object (MO)) may be forced to request actions in a serial manner, one-by-one. As a consequence, performing complex tasks may require elaborative, verbose communication with a NMS.

Examples of the present disclosure introduce a vendor ecosystem agnostic application programming interface (API), which may be referred to herein as an “actions API,” and which may provide applications with access to both simple and compound actions/tasks. In one example, applications may select from a catalog the actions/tasks that are requested to be performed/executed. In one example, applications may also indicate via the actions API an order in which such actions are to be executed. In addition, in one example, the action(s) may be requested on a per-managed object (MO) basis. Such actions may be pre-implemented and are made available to applications in a catalog/library of tasks and/or action. Notably, the actions may be invoked as reusable blocks and can be viewed as intent-driven tasks. The actions can be ordered in any arbitrary way and form a pipeline that will be executed by the Actions API controller (e.g., as a task comprising one or more operations/actions). In one example, the present disclosure may further include pre-implemented pipelines comprising a set of multiple actions that can be used by applications off-the-shelf. For instance, a pre-implemented pipeline may be particularly useful in scenarios where certain actions are to be performed in a specific order (in one example, the details of which may be unknown to the application developer). For instance, application developers may lack network platform knowledge and may be unaware of the sequence of actions that should be performed in order to make specific cell site or cell's parameter changes, or may be unable to express whether some of these actions should be done sequentially or in parallel.

In one example, the present disclosure may include both live and simulation/emulation modes. For instance, in a live mode, the action/tasks are performed on the live network and changes are actually implemented at the target network elements/managed objects. On the other hand, in simulation mode, the action changes are simulated in an emulation environment, but are not performed on the actual target network elements. This enables application developers to test and validate end-to-end flow of the automation applications without affecting actual network performance. However, if the simulation mode reveals that the actions are correct, the live mode can be quickly activated by a parameter switch.

In one example, examples of the present disclosure may be deployed in an Open Network Automation Platform (ONAP)-based platform. Alternatively, or in addition, examples of the present disclosure may be deployed in an operations support system (OSS) for 4G/5G networks, may relate to open radio access network (ORAN)-based APIs (e.g., O1, R1, E1, and/or future developed interfaces), and may alternatively or additionally be expanded/adopted to 6G or other future-developed systems. In one example, an actions API of the present disclosure may be implemented via, and may comprise an integral and functional part of a service management and orchestration (SMO) platform developed based on an ORAN architecture and utilizing interfaces provided by industry vendors and network operators.

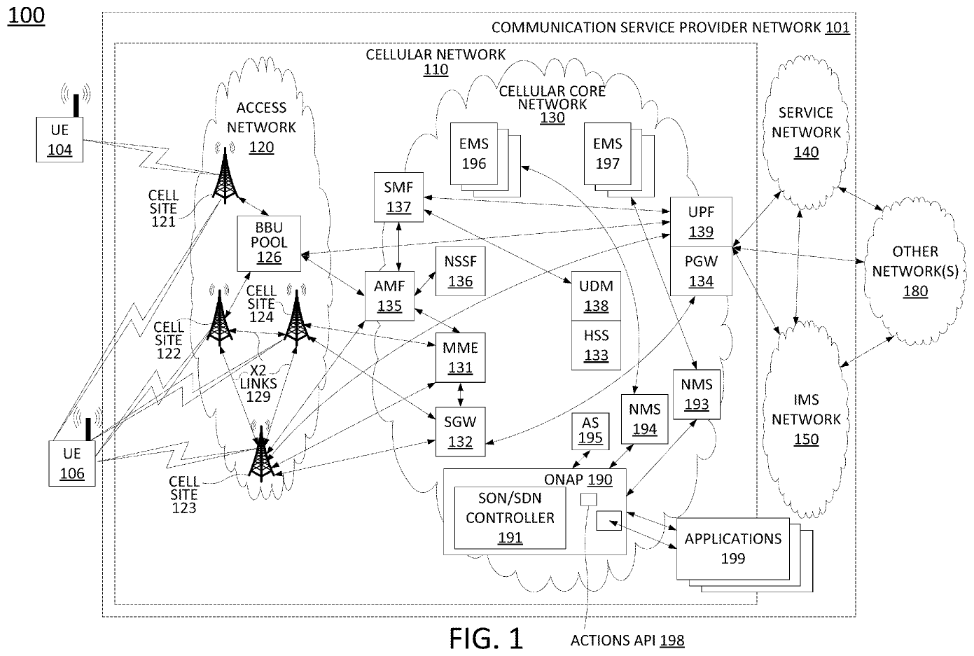

Thus, examples of the present disclosure provide a comprehensive interface for automated applications to invoke read/write operations (and more complex tasks/actions based thereon) towards an LTE/5G network without the need to implement application-specific software features for such actions. For instance, an actions API of the present disclosure may offer sufficient detail to accommodate a large variety of applications and actions towards the communication network in a fully automated fashion. This results in fast application onboarding and rollout due to reduced implementation requirements for customized features, easier network troubleshooting and alarming in a unified manner, and expedited software maintenance and extension support. In addition, examples of the present disclosure may be extended to operate beyond the area of wireless broadband networking. For instance, examples of the present disclosure may be applied in various types of communication networks that supports read/write operations via the apriori definition of managed objects (MOs) for describing network parameters, such as core network environments, transport network environments, fiber access network environments, and so forth. These and other aspects of the present disclosure are discussed in greater detail below in connection with the examples of FIGS. 1-6.

FIG. 1 illustrates an example network, or system 100 in which examples of the present disclosure may operate. In one example, the system 100 includes a communication service provider network 101. The communication service provider network 101 may comprise a cellular network 110 (e.g., a 4G/Long Term Evolution (LTE) network, a 4G/5G hybrid network, or the like), a service network 140, and an IP Multimedia Subsystem (IMS) network 150. The system 100 may further include other networks 180 connected to the communication service provider network 101. In one example, the cellular network 110 comprises an access network 120 and a cellular core network 130. In one example, the access network 120 comprises a cloud radio access network (RAN). For instance, a cloud RAN is part of the 3GPP 5G specifications for mobile networks. As part of the migration of cellular networks towards 5G, a cloud RAN may be coupled to an Evolved Packet Core (EPC) network until new cellular core networks are deployed in accordance with 5G specifications. In one example, access network 120 may include cell sites 121 and 122 and a baseband unit (BBU) pool 126. In a cloud RAN, radio frequency (RF) components, referred to as remote radio heads (RRHs), may be deployed remotely from baseband units, e.g., atop cell site masts, buildings, and so forth. In one example, the BBU pool 126 may be located at distances as far as 20-80 kilometers or more away from the antennas/remote radio heads of cell sites 121 and 122 that are serviced by the BBU pool 126. It should also be noted in accordance with efforts to migrate to 5G networks, cell sites may be deployed with new antenna and radio infrastructures such as multiple input multiple output (MIMO) antennas, and millimeter wave antennas. In this regard, a cell, e.g., the footprint or coverage area of a cell site may in some instances be smaller than the coverage provided by NodeBs or eNodeBs of 3G-4G RAN infrastructure. For example, the coverage of a cell site utilizing one or more millimeter wave antennas may be 1000 feet or less.

Although cloud RAN infrastructure may include distributed RRHs and centralized baseband units, a heterogeneous network may include cell sites where RRH and BBU components remain co-located at the cell site. For instance, cell site 123 may include RRH and BBU components. Thus, cell site 123 may comprise a self-contained “base station.” With regard to cell sites 121 and 122, the “base stations” may comprise RRHs at cell sites 121 and 122 coupled with respective baseband units of BBU pool 126. In accordance with the present disclosure, any one or more of cell sites 121-123 may be deployed with antenna and radio infrastructures, including multiple input multiple output (MIMO) and millimeter wave antennas.

In one example, access network 120 may include both 4G/LTE and 5G/NR radio access network infrastructure. For example, access network 120 may include cell site 124, which may comprise 4G/LTE base station equipment, e.g., an eNodeB. In addition, access network 120 may include cell sites comprising both 4G and 5G base station equipment, e.g., respective antennas, feed networks, baseband equipment, and so forth. For instance, cell site 123 may include both 4G and 5G base station equipment and corresponding connections to 4G and 5G components in cellular core network 130. Although access network 120 is illustrated as including both 4G and 5G components, in another example, 4G and 5G components may be considered to be contained within different access networks. Nevertheless, such different access networks may have a same wireless coverage area, or fully or partially overlapping coverage areas.

As illustrated in FIG. 1, cell sites, or base stations (e.g., cell sites 122-124), may be connected to each other via X2 links 129. X2 links may be implemented via physical links, e.g., fiber connections, wireless base station-to-base station links, or virtual links. For instance, with respect to virtual links, in the example of FIG. 1, cell site 121 and cell site 122 may comprise base stations that are implemented at least partially on shared hardware (e.g., BBU pool 126) such that no external physical or wireless link is used. Similarly, to the extent that 5G and LTE infrastructure may be implemented at the same cell site/base station, an X2 interface may similarly be virtual in nature, or may comprise a short physical connection between two sets of co-located base station equipment. In one example, the cellular core network 130 provides various functions that support wireless services in the LTE environment. In one example, cellular core network 130 is an Internet Protocol (IP) packet core network that supports both real-time and non-real-time service delivery across a LTE network, e.g., as specified by the 3GPP standards. In one example, cell sites 121 and 122 in the access network 120 are in communication with the cellular core network 130 via baseband units in BBU pool 126.

In cellular core network 130, network devices such as Mobility Management Entity (MME) 131 and Serving Gateway (SGW) 132 support various functions as part of the cellular network 110. For example, MME 131 is the control node for LTE access network components, e.g., eNodeB aspects of cell sites 121-123. In one example, MME 131 is responsible for user equipment (UE) tracking and paging (e.g., such as retransmissions), bearer activation and deactivation process, selection of the SGW, and authentication of a user. In one example, SGW 132 routes and forwards user data packets, while also acting as the mobility anchor for the user plane during inter-cell handovers and as an anchor for mobility between 5G, LTE and other wireless technologies, such as 2G and 3G wireless networks. In addition, cellular core network 130 may comprise a Home Subscriber Server (HSS) 133 that contains subscription-related information (e.g., subscriber profiles), performs authentication and authorization of a wireless service user, and provides information about the subscriber's location. The cellular core network 130 may also comprise a packet data network (PDN) gateway (PGW) 134 which serves as a gateway that provides access between the cellular core network 130 and various packet data networks (PDNs), e.g., service network 140, IMS network 150, other network(s) 180, and the like.

The foregoing describes long term evolution (LTE) cellular core network components (e.g., EPC components). In accordance with the present disclosure, cellular core network 130 may further include other types of wireless network components e.g., 2G network components, 3G network components, 5G network components, etc. Thus, cellular core network 130 may comprise an integrated network, e.g., including any two or more of 2G-5G infrastructures and technologies, and the like. For example, as illustrated in FIG. 1, cellular core network 130 further comprises 5G components, including: an access and mobility management function (AMF) 135, a network slice selection function (NSSF) 136, a session management function (SMF), a unified data management function (UDM) 138, and a user plane function (UPF) 139.

In one example, AMF 135 may perform registration management, connection management, endpoint device reachability management, mobility management, access authentication and authorization, security anchoring, security context management, coordination with non-5G components, e.g., MME 131, and so forth. NSSF 136 may select a network slice or network slices to serve an endpoint device, or may indicate one or more network slices that are permitted to be selected to serve an endpoint device. For instance, in one example, AMF 135 may query NSSF 136 for one or more network slices in response to a request from an endpoint device to establish a session to communicate with a PDN. The NSSF 136 may provide the selection to AMF 135, or may provide one or more permitted network slices to AMF 135, where AMF 135 may select the network slice from among the choices. A network slice may comprise a set of cellular network components, such as AMF(s), SMF(s), UPF(s), and so forth that may be arranged into different network slices which may logically be considered to be separate cellular networks. In one example, different network slices may be preferentially utilized for different types of services. For instance, a first network slice may be utilized for sensor data communications, Internet of Things (IoT), and machine-type communication (MTC), a second network slice may be used for streaming video services, a third network slice may be utilized for voice calling, a fourth network slice may be used for gaming services, and so forth.

In one example, SMF 137 may perform endpoint device IP address management, UPF selection, UPF configuration for endpoint device traffic routing to an external packet data network (PDN), charging data collection, quality of service (QoS) enforcement, and so forth. UDM 138 may perform user identification, credential processing, access authorization, registration management, mobility management, subscription management, and so forth. As illustrated in FIG. 1, UDM 138 may be tightly coupled to HSS 133. For instance, UDM 138 and HSS 133 may be co-located on a single host device, or may share a same processing system comprising one or more host devices. In one example, UDM 138 and HSS 133 may comprise interfaces for accessing the same or substantially similar information stored in a database on a same shared device or one or more different devices, such as subscription information, endpoint device capability information, endpoint device location information, and so forth. For instance, in one example, UDM 138 and HSS 133 may both access subscription information or the like that is stored in a unified data repository (UDR) (not shown).

UPF 139 may provide an interconnection point to one or more external packet data networks (PDN(s)) and perform packet routing and forwarding, QoS enforcement, traffic shaping, packet inspection, and so forth. In one example, UPF 139 may also comprise a mobility anchor point for 4G-to-5G and 5G-to-4G session transfers. In this regard, it should be noted that UPF 139 and PGW 134 may provide the same or substantially similar functions, and in one example, may comprise the same device, or may share a same processing system comprising one or more host devices.

It should be noted that other examples may comprise a cellular network with a “non-stand alone” (NSA) mode architecture where 5G radio access network components, such as a “new radio” (NR), “gNodeB” (or “gNB”), and so forth are supported by a 4G/LTE core network (e.g., an EPC network), or a 5G “standalone” (SA) mode point-to-point or service-based architecture where components and functions of an EPC network are replaced by a 5G core network (e.g., an “NC”). For instance, in non-standalone (NSA) mode architecture, LTE radio equipment may continue to be used for cell signaling and management communications, while user data may rely upon a 5G new radio (NR), including millimeter wave communications, for example. However, examples of the present disclosure may also relate to a hybrid, or integrated 4G/LTE-5G cellular core network such as cellular core network 130 illustrated in FIG. 1. In this regard, FIG. 1 illustrates a connection between AMF 135 and MME 131, e.g., an “N26” interface which may convey signaling between AMF 135 and MME 131 relating to endpoint device tracking as endpoint devices are served via 4G or 5G components, respectively, signaling relating to handovers between 4G and 5G components, and so forth.

In one example, service network 140 may comprise one or more devices for providing services to subscribers, customers, and or users. For example, communication service provider network 101 may provide a cloud storage service, web server hosting, and other services. As such, service network 140 may represent aspects of communication service provider network 101 where infrastructure for supporting such services may be deployed. In one example, other networks 180 may represent one or more enterprise networks, a circuit switched network (e.g., a public switched telephone network (PSTN)), a cable network, a digital subscriber line (DSL) network, a metropolitan area network (MAN), an Internet service provider (ISP) network, and the like. In one example, the other networks 180 may include different types of networks. In another example, the other networks 180 may be the same type of network. In one example, the other networks 180 may represent the Internet in general. In this regard, it should be noted that any one or more of service network 140, other networks 180, or IMS network 150 may comprise a packet data network (PDN) to which an endpoint device may establish a connection via cellular core network 130 in accordance with the present disclosure.

In one example, any one or more of the components of cellular core network 130 may comprise network function virtualization infrastructure (NFVI), e.g., SDN host devices (i.e., physical devices) configured to operate as various virtual network functions (VNFs), such as a virtual MME (vMME), a virtual HHS (vHSS), a virtual serving gateway (vSGW), a virtual packet data network gateway (vPGW), and so forth. For instance, MME 131 may comprise a vMME, SGW 132 may comprise a vSGW, and so forth. Similarly, AMF 135, NSSF 136, SMF 137, UDM 138, and/or UPF 139 may also comprise NFVI configured to operate as VNFs. In addition, when comprised of various NFVI, the cellular core network 130 may be expanded (or contracted) to include more or less components than the state of cellular core network 130 that is illustrated in FIG. 1.

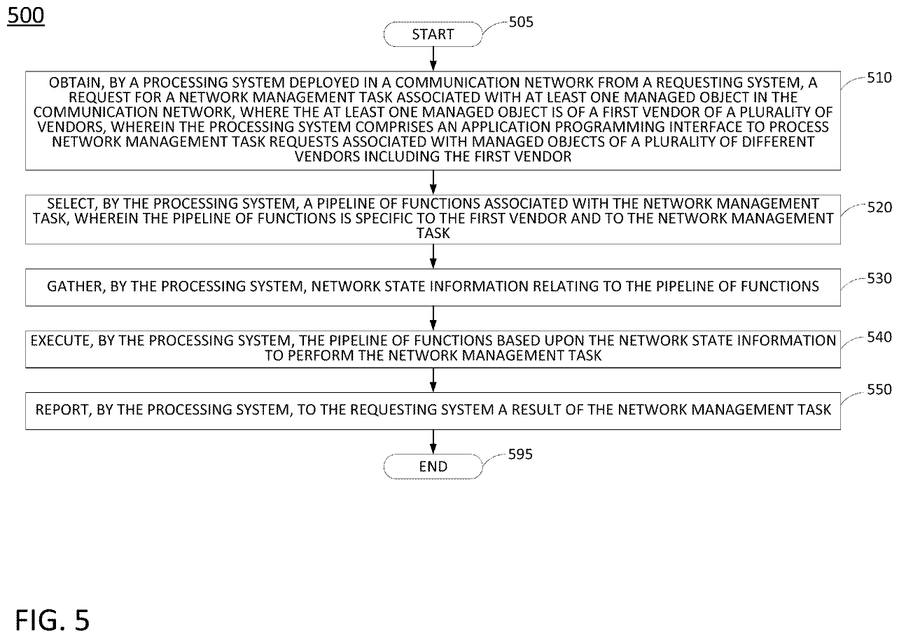

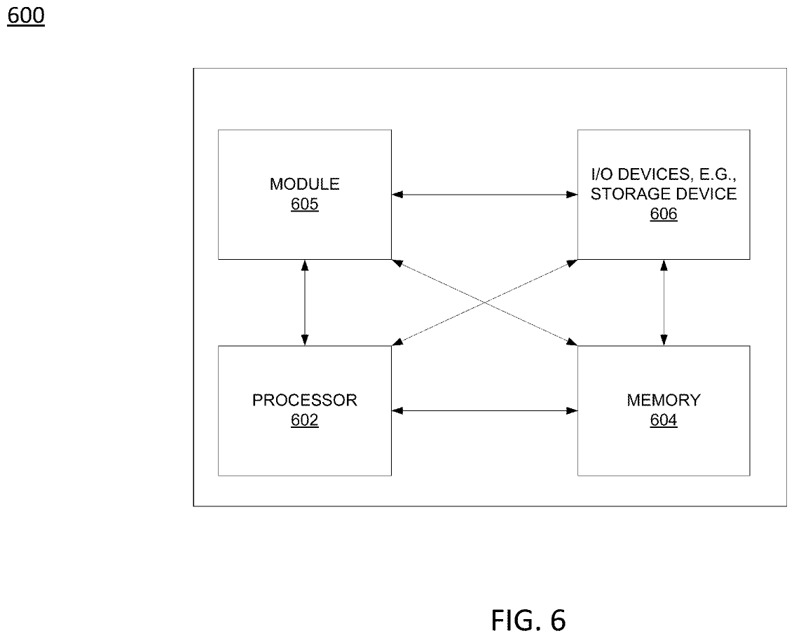

In this regard, the cellular core network 130 may also include an Open Network Access Platform (ONAP) 190 for management and orchestration of physical and virtual network functions and services. ONAP 190 may include various components, such as an ONAP operations manager (OOM), an active and available inventory (AAI), and a self-optimizing network (SON)/software defined network (SDN) controller 191. In one example, SON/SDN controller 191 may function as a self-optimizing network (SON) orchestrator that is responsible for activating and deactivating, allocating and deallocating, and otherwise managing a variety of network components. In accordance with the present disclosure, ONAP 190 and/or any one or more components thereof, such as SON/SDN controller 191, may comprise all or a portion of a computing system, such as computing system 600 as depicted in FIG. 6, and may be configured to provide one or more functions for selecting and executing a pipeline of functions specific to a first vendor and to a network management task based upon network state information, as described herein. For instance, an example method 500 for selecting and executing a pipeline of functions specific to a first vendor and to a network management task based upon network state information is illustrated in FIG. 5 and described in greater detail below.

It should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 6 and discussed below) or multiple computing devices collectively configured to perform various steps, functions, and/or operations in accordance with the present disclosure.

In one example, SON/SDN controller 191 may activate and deactivate antennas/remote radio heads of cell sites 121 and 122, respectively, may steer antennas/remote radio heads (RRHs) of cell sites 121 and 122 (e.g., adjusting vertical tilt angles, azimuth bearings, beamwidths, power levels, and or other settings), may allocate or deallocate (or activate or deactivate) baseband units in BBU pool 126 and/or RRHs (e.g., to provide additional active base stations or sectors (e.g., where such physical components are already deployed and installed, but are inactive), may add (or remove) one or more network slices, may adjust various values of configuration parameters for carriers in operation at the various cell sites 121-124 of the cellular network 110, e.g., a handover margin, an inter-frequency load balancing activation status, a downlink interference generation enable status, an active mode load equalization enable status, an average uplink load biasing parameter for secondary cell selection, an inter-cell load generation for physical downlink control channel enable status, a physical downlink control channel load level parameter, an inter-frequency quality threshold for reselecting a higher priority frequency, an reference signal received power inter-frequency handover margin for handover to a neighboring base station, an inter-frequency load balancing threshold for reference signal received power target cell filtering, a hysteresis threshold for a handover margin for handover to wideband code division multiple access, a minimum transmit reference signal received power level in a cell, a reselection threshold for evaluating a lower priority frequency or a lower priority radio access technology, and so forth. SON/SDN controller 191 may perform various other operations for adjusting configurations of components of cellular network 110 in accordance with the present disclosure.

In one example, SON/SDN controller 191 may further comprise a SDN controller that is responsible for instantiating, configuring, managing, and releasing VNFs. For example, in a SDN architecture, a SDN controller may instantiate VNFs on shared hardware, e.g., NFVI/host devices/SDN nodes, which may be physically located in various places. In one example, the configuring, releasing, and reconfiguring of SDN nodes is controlled by the SDN controller, which may store configuration codes, e.g., computer/processor-executable programs, instructions, or the like for various functions which can be loaded onto an SDN node. In another example, the SDN controller may instruct, or request an SDN node to retrieve appropriate configuration codes from a network-based repository, e.g., a storage device, to relieve the SDN controller from having to store and transfer configuration codes for various functions to the SDN nodes.

Accordingly, ONAP 190 and/or SON/SDN controller 191 thereof may be connected directly or indirectly to any one or more network elements of cellular core network 130, and of the system 100 in general. Due to the relatively large number of connections available between SON/SDN controller 191 and other network elements, various ones of the actual links to the SON/SDN controller 191 are omitted from illustration in FIG. 1. Similarly, intermediate devices and links between MME 131, SGW 132, cell sites 121-124, PGW 134, AMF 135, NSSF 136, SMF 137, UDM 138, and/or UPF 139, and other components of system 100 are also omitted for clarity, such as additional routers, switches, gateways, and the like.

FIG. 1 also illustrates various endpoint devices, e.g., user equipment (UE) 104 and 106. UE 104 and 106 may each comprise a cellular telephone, a smartphone, a tablet computing device, a laptop computer, a pair of computing glasses, a wireless enabled wristwatch, a wireless transceiver for a fixed wireless broadband (FWB) deployment, or any other cellular-capable mobile telephony and computing device (broadly, “an endpoint device”). In one example, each of UE 104 and UE 106 may each be equipped with one or more directional antennas, or antenna arrays (e.g., having a half-power azimuthal beamwidth of 120 degrees or less, 90 degrees or less, 60 degrees or less, etc.), e.g., MIMO antenna(s) to receive multi-path and/or spatial diversity signals. Each of UE 104 and UE 106 may also include a gyroscope and compass to determine orientation(s), a global positioning system (GPS) receiver for determining a location (e.g., in latitude and longitude, or the like), and so forth. In one example, each of UE 104 and UE 106 may include a built-in/embedded barometer from which measurements may be taken and from which an altitude or elevation of the respective endpoint device may be determined. In one example, each of UE 104 and UE 106 may also be configured to determine location/position from near field communication (NFC) technologies, such as Wi-Fi direct and/or other IEEE 802.11 communications or sensing (e.g., in relation to beacons or reference points in an environment), IEEE 802.15 based communications or sensing (e.g., “Bluetooth®,” “ZigBee™” etc.), and so forth.

As illustrated in FIG. 1, UE 104 may access wireless services via the cell site 121 (e.g., NR alone, where cell site 121 comprises a gNB), while UE 106 may access wireless services via any of cell sites 121-124 located in the access network 120 (e.g., for NR non-dual connectivity, for LTE non-dual connectivity, for NR-NR DC, for LTE-LTE DC, for EN-DC, and/or for NE-DC). For instance, in one example, UE 106 may establish and maintain connections to the cellular core network 130 via multiple gNBs (e.g., cell sites 121 and 122 and/or cell sites 121 and 122 in conjunction with BBU pool 126). In another example, UE 106 may establish and maintain connections to the cellular core network 130 via a gNB (e.g., cell site 122 and/or cell site 122 in conjunction with BBU pool 126) and an eNodeB (e.g., cell site 124), respectively. In addition, either the gNB or the eNodeB may comprise a PCell, and the other may comprise a SCell for dual connectivity, as described herein. Furthermore, either or both of NR/5G and or EPC (4G/LTE) core network components may manage the communications between UE 106 and the cellular network 110) via cell site 122 and cell site 124.

In one example, UE 106 may also utilize different antenna arrays for 4G/LTE and 5G/NR, respectively. For instance, 5G antenna arrays may be arranged for beamforming in a frequency band designated for 5G high data rate communications. For instance, the antenna array for 5G may be designed for operation in a frequency band greater than 5 GHz. In one example, the array for 5G may be designed for operation in a frequency band greater than 20 GHz. In contrast, an antenna array for 4G may be designed for operation in a frequency band less than 5 GHz, e.g., 500 MHz to 3 GHz. In addition, in one example, the 4G antenna array (and/or the RF or baseband processing components associated therewith) may not be configured for and/or be capable of beamforming. Accordingly, in one example, UE 106 may turn off a 4G/LTE radio, and may activate a 5G radio to send a request to activate a 5G session to cell site 122 (e.g., when it is chosen to operate in a non-DC mode or an intra-RAT dual connectivity mode), or may maintain both radios in an active state for multi-radio (MR) dual connectivity (MR-DC).

In one example, ONAP 190 may be in communication with network management systems (NMSs), e.g., NMS 193 and NMS 194. NMS 193 may be associated with a first vendor, while NMS 194 may be associated with a second vendor of network equipment. As noted above, these (NMSs) may expose northbound APIs for machine-to-machine (M2M) connectivity. In the example of FIG. 1, cellular core network 130 may further include element management systems (EMSs) 196 and 197. For instance, a plurality of EMSs 196 may be associated with the first vendor and a plurality of EMSs 197 may be associated with the second vendor. In one example, ONAP 190, NMSs 193 and 194, and EMSs 196 and 197 may individually or collectively provide and/or perform various FCAPS functions (fault management, configuration management, account management, performance management, and security management). In various examples, FCAPS functions may be distributed among ONAP 190, NMSs 193 and 194, and EMSs 196 and 197. However, in some example, some or all FCAPS functions may have overlapping functionality and/or redundancy, or may be provided by alternative selectable entities via which the same or similar functionality may be invoked by other entities, such as automated applications 199. In this regard, it should be noted that applications 199 may be internal or external to ONAP 190, as described in greater detail below. To further illustrate, EMSs 196 and 197 may be assigned to manage sets of one or more network elements (of the first vendor or the second vendor, respectively) on an individualized basis. In one example, the network elements may be of a same type, e.g., one of EMSs 196 may be for managing SMFs of the first vendor, another one of EMSs 196 may be for managing UPFs of the first vendor, etc. On the other hand, NMSs 193 and 194 may manage network elements (of the first vendor or the second vendor, respectively) collectively as well as on an individualized basis. For instance, NMS 193 may identify root causes, may optimize parameters/configuration settings, etc. based on aggregation and correlation among different network elements. In one example, the aggregation/correlation may also extend across network element types.

In one example, NMSs 193 and 194 may communicate directly with managed network elements (e.g., where intermediate devices/links within a communication path may serve merely as a conduit for message exchange). Alternatively, or in addition, NMSs 193 and 194 may operate in hierarchical relationships with EMSs 196 and 197, respectively. For instance, NMS 193 may identify a root cause of a network performance degradation based upon aggregation/correlation of status data from network elements of various types, where the root cause may be isolated to a configuration error in SMF 137. In addition, SMF 137 may be assigned to/associated with a particular one of EMSs 196. As such, NMS 193 may request/instruct the assigned EMS 196 to reconfigure SMF 137 accordingly. In addition, in accordance with the present disclosure ONAP 190 may maintain an overall network view and provide FCAPS functionality across network elements of various types and of various vendors. For instance, ONAP 190 may similarly monitor status of various network elements, may identify root causes, may remotely reconfigure network elements in response to changing network conditions, and so forth. However, in one example, ONAP 190 may perform read (e.g., status monitoring) and write operations (e.g., configuring/reconfiguring) via NMSs 193 and 194, respectively. For instance, ONAP 190 may request/instruct NMS 193 to reconfigure SMF 137 in response to a root cause, in response to changing network conditions that indicate SMF 137 should be reconfigured, etc. It should again be noted that in one example, NMS 193 may interact directly with SMF 137 and/or other managed network elements, or may further instruct/request EMSs 196 to obtain status information of managed network elements via EMSs 196 as intermediaries.

In one example, ONAP 190 itself may gather, record, monitor, and adapt the network in response to operational data (e.g., status information) of various network elements. As referred to herein, operational data may comprise network element configuration parameters/settings (e.g., antenna tilt, beamwidth, transmit power, compute resources allocated to a VM (e.g., max processor availability, max memory allocated to the VM, etc.), a class/quality label assigned to a device, customer, customer premises, and/or particular traffic thereof, etc.) as well as network measurements and/or computed performance indicators (e.g., “key performance indicators” (KPIs)), such as peak and average processor utilization, average memory utilization, bandwidth utilization, or the like, packet loss rate, call failure rate, call drop rate, packet delay, packet throughput, jitter, signal to noise (SNR) ratio on various wireless channels, e.g., between UEs 104 and 106 and any of cell sites 121-124, device temperatures of various network elements, other alarm data, and so forth. In one example, ONAP 190 may enable or disable optional functionality of NMSs 193 and/or 194, and similarly for EMSs 196 and 197. For instance, ONAP 190 may delegate threshold monitoring to NMS 194, may reserve such functionality for itself, or may allow NMS 194 to continue to perform independent threshold monitoring in parallel to ONAP 190, where ONAP 190 may utilize alerts/alarms from NMS 194 as verification of those that are generated at ONAP 190 itself.

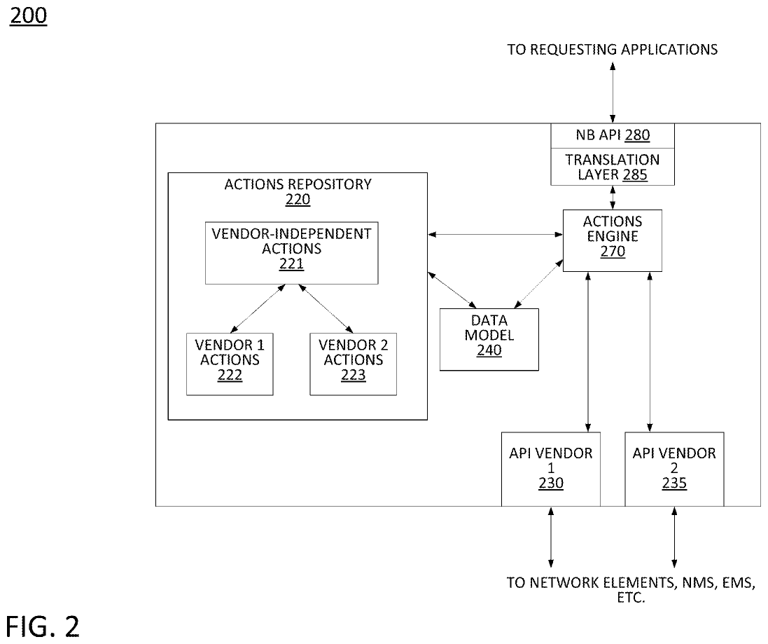

As further illustrated in FIG. 1, ONAP 190 may include an actions API 198 (or an actions API controller). As noted above, in accordance with the present disclosure, actions API 198 may provide a comprehensive interface for automated applications to invoke read/write operations (and more complex tasks/actions based thereon) towards an LTE/5G network without the need to implement application-specific software features for such actions. Thus, for example, applications 199 may utilize actions API 198 to provide read and write operations with respect to various network elements of any vendor type in a unified manner, where each network element and or aspects thereof may be presented as a managed object (MO). The read operations may include obtaining configuration settings/parameters and/or performance indicator data. The write operations may include changing one or more configuration settings/parameters to change the state of the network element and/or the network. As illustrated in FIG. 1, the applications 199 may be part of the ONAP 190 or may be external applications. For instance, as network technology continues to evolve, the ONAP 190 may be expanded to include new or different functionality via applications 199. For example, new or different FCAPS functionality as mentioned above may be provided via applications 199. To illustrate, applications 199 may include an application for identifying and implementing energy saving measures. In addition, applications 199 may include an application for identifying and implementing traffic offloading candidates. These applications may work in parallel regarding their respective tasks, while the combined functionality is provided by ONAP 190. However, in other examples, there may be independent energy savings and traffic offloading applications which may obtain configuration settings/parameters and/or performance indicator data via ONAP 190 and the actions API 198, and/or which may request reconfiguration of the network, sets of network elements, and/or specific network elements via the ONAP 190 and the actions API 198. In this regard, one or more of application 199 may be associated with and/or may comprise another device or system within communication service provider network 101. Additional features of actions API 198 may be as described in greater detail below in connection with the example actions API controller 200 of FIG. 2.

In one example, the cellular core network 130 further includes an application server (AS) 195. For instance, AS 195 may comprise all or a portion of a computing system, such as computing system 600 as depicted in FIG. 6, and may be configured to perform operations for selecting and executing a pipeline of functions specific to a first vendor and to a network management task based upon network state information. For example, AS 195 may perform such operations as an alternative to, or in addition to ONAP 190. For instance, the actions API 198 may be isolated to AS 195, where other aspects of ONAP 190 may remain within the platform of ONAP 190. In still another example, AS 195 may represent an operations support system (OSS) which may provide FCAPS functionality, where SON/SDN controller 191 may be a separate entity that may be invoked by such an OSS in connection with reconfiguring of network elements. As noted above, in one example, the present disclosure may also provide a simulation/emulation environment. In one example, AS 195 may host a simulation/emulation environment in which the state of the communication service provider network 101 may be emulated, and where various read and write (e.g., configure/reconfigure) operations may be simulated to obtain a forecast new state of the communication service provider network 101 and/or aspects thereof (e.g., new states of network zones, specific network elements, links, etc.).

The foregoing description of the system 100 is provided as an illustrative example only. In other words, the example of system 100 is merely illustrative of one network configuration that is suitable for implementing examples of the present disclosure. As such, other logical and/or physical arrangements for the system 100 may be implemented in accordance with the present disclosure. For example, the system 100 may be expanded to include additional networks, such as network operations center (NOC) networks, additional access networks, and so forth. The system 100 may also be expanded to include additional network elements such as border elements, routers, switches, policy servers, security devices, gateways, a content distribution network (CDN) and the like, without altering the scope of the present disclosure. In addition, system 100 may be altered to omit various elements, substitute elements for devices that perform the same or similar functions, combine elements that are illustrated as separate devices, and/or implement network elements as functions that are spread across several devices that operate collectively as the respective network elements.

For instance, in one example, the cellular core network 130 may further include a Diameter routing agent (DRA) which may be engaged in the proper routing of messages between other elements within cellular core network 130, and with other components of the system 100, such as a call session control function (CSCF) (not shown) in IMS network 150. In another example, the NSSF 136 may be integrated within the AMF 135. In addition, cellular core network 130 may also include additional 5G NG core components, such as: a policy control function (PCF), an authentication server function (AUSF), a network repository function (NRF), and other application functions (AFs). In one example, any one or more of cell sites 121-124 may comprise 2G, 3G, 4G and/or LTE radios, e.g., in addition to 5G new radio (NR), or gNB functionality. For instance, cell site 123 is illustrated as being in communication with AMF 135 in addition to MME 131 and SGW 132.

In addition, it should be noted that other examples may extend to non-cellular communication networks, or non-cellular aspects of a communication network, such as fiber access network environments, backbone/transport network environments, metropolitan area network environments, content distribution network environments, including video distribution network environments, and so forth. Thus, in various examples, managed network elements/components may include various types of optical network equipment, such as an optical network terminal (ONT), an optical network unit (ONU), an optical line amplifier (OLA), a fiber distribution panel, a fiber cross connect panel, and so forth. Similarly, network elements may alternatively or additionally include voice communication components, such as a call server, an echo cancellation system, voicemail equipment, a private branch exchange (PBX), etc., short message service (SMS)/text message infrastructure, such as an SMS gateway, a short message service center (SMSC), or the like, video distribution infrastructure, such as a media server (MS), a video on demand (VoD) server, a content distribution node (CDN), and so forth. Network elements may further include various other types of communication network equipment such as a layer 3 router, e.g., a provider edge (PE) router, an integrated services router, etc., an internet exchange point (IXP) switch, and so on. It should again be noted that network elements may further include virtual components, such as a virtual machine (VM), a virtual container, etc., software defined network (SDN) nodes, such as a virtual mobility management entity (vMME), a virtual serving gateway (vSGW), a virtual network address translation (NAT) server, a virtual firewall server, or the like, and so forth. Still other network elements may include a Simple Network Management Protocol (SNMP) trap, or the like, a billing system, a customer relationship management (CRM) system, a trouble ticket system, an inventory system (IS), an ordering system, an enterprise reporting system (ERS), an account object (AO) database system, and so forth. It should be noted that in one example, a communication network element/component may be hosted on a single server, while in another example, a communication network component may be hosted on multiple servers, e.g., in a distributed manner. Thus, these and other modifications are all contemplated within the scope of the present disclosure.

FIG. 2 illustrates an example actions API controller 200 (e.g., implemented via a processing system including at least one processor, such as a component of an ONAP, OSS, or the like, and/or as an independent processing system). In one example, the translation layer 285 may be responsible for translation from a schema of the northbound (NB) API 280 to internal data model 240. For instance, the translation layer 285 may enable support for multiple NB APIs. The internal data model 240 may be used by various components (independent from the NB API model/schema). The actions repository 220 may maintain a set of action implementations per vendor and action type (e.g., vendor 1 actions 222 and vendor 2 actions 223). Vendor-independent actions 221 are also registered in the action repository 220. It should be noted that actions/functions implement the logic for processing managed objects (MOs) represented by the internal data model 240. Vendor-independent actions 221 implement vendor-independent logic using other actions from vendor 1 actions 222 and or vendor 2 actions 223. The actions engine 270 may retrieve actions (also referred to herein as functions or operations) from the actions repository 220 and execute sequences of actions from requests from various client applications (e.g., requests for network management tasks). In particular, the actions engine 270 may identify sequences of one or more actions (e.g., a pipeline of functions/actions/operations) from the vendor-independent actions 221. The selected vendor-independent actions may then be mapped to corresponding ones of the vendor 1 actions 222 and/or vendor 2 actions 223 (e.g., vendor-specific actions). The vendor-specific actions may then be carried out via an API of vendor 1, 230, or an API of vendor 2, 235, respectively.

In one example, a requesting application/system can specify a pipeline, or it can be unaware of the particular actions required to complete an overall task, and can instead request the desired parameters, in response to which the actions API controller 200 may find the right pipeline and adapt the pipeline based on current network state. For example, a client system/application may request to configure three cells A, B, and C. However, to configure the cells, it may be the case that the cells should first be locked (e.g., stop/block traffic on cells), then configured, and then unlocked to re-allow traffic In accordance with the present disclosure, the actions API controller 200 may thus determine if locking of the cells needs to be performed. For instance, one or more of the cells could already be locked. Accordingly, actions API controller 200 may first read the state of the cells to see if any are already in a locked state (e.g., via API 230 of vendor 1 and/or API 235 of vendor 2). For illustrative purposes, it may be found that cell A is already locked. For instance, another user or system/application may have already locked cell A for some other reason. As such, based on the current network state, the actions API controller (e.g., via the actions engine 270 thereof) may adapt the pipeline to only execute lock commands for cells B and C. Then, in the next phase of the pipeline it may push parameter configurations to configure the cells. In the last phase, the cells may be unlocked, but it may only unlock B and C. In particular, since cell A was previously locked, cell A may be returned in the locked state (but it may save the other parameter changes that may have been made such that the parameters are in place when cell A is later unlocked). Notably, if the pipeline were to be executed in a hardcoded way, then it would include wasteful processing of a redundant command locking A. In addition, more problematic, it would also return cell A in an unlocked state which may cause undesired outcomes. It should be noted that other examples may be even more complex. For instance, there may be a particular order to first lock 4G, then lock 5G, then unlock 5G, followed by unlocking 4G, subject to the constraint that a cell lock status be unchanged at the conclusion of all pipeline actions.

In addition to the foregoing, actions API controller 200 may also alleviate client systems/applications from having to address irregularities in pipeline action execution. For instance, actions API controller 200 may obtain a request from a client system/application, obtain a snapshot of network state, and then identify the correct actions and the order thereof to achieve the desired configurations in a seamless and reliable way without the system/application or designer needing to worry about the order of operations. In addition, where there may be a problem in execution, such as a non-acknowledgement or delay, actions API controller 200 may determine whether to wait, how long to wait, whether to re-execute, whether to cancel, etc. For instance, in the above example, if there is a failure in unlocking cell C at the end of the process, actions API controller 220 may try a few times to repair the cell. If the repair still fails, actions API controller 220 may raise an alarm to escalate to network personnel or another automated system.

Notably, vendor-independent actions 221 can leverage new action implementations of vendor 1 actions 222 and vendor 2 actions 223 without modifying the associated ones of vendor-independent actions 221. In addition, in one example, new implementations of vendor-independent actions 221 may reuse other vendor-independent actions and/or vendor-specific actions. It should also be noted that vendor-specific actions (e.g., vendor 1 actions 222 and vendor 2 actions 223) may reuse other vendor-specific actions (e.g., of the same vendor only). To further illustrate, vendor-independent actions 221 may comprise templates for implementation of reusable vendor-agnostic business logic, e.g.: PRE_CHECK, POST_CHECK, WRITE_CONFIG_WITH_LOCK, etc., while actions engine 270 may comprise a module for implementation of new processing capabilities for all actions and sequences of actions e.g.: batching, expiry-time, etc.

In one example, the actions API controller 200 may use request and response messages based on the REST (Representational State Transfer) messaging format. The NB API 280 may be exposed to the applications that intend to provide action requests. Such request and response messages, being RESTful messages, can be exchanged between application(s) and the actions API controller 200 either via direct calls, or via intermediary message-delivery services, such as Kafka queuing systems (for example via a data movement as a platform (DMaaP) message router, or the like). In one example, each request may contain basic information, such as the NMS system that will be used and the identification of the requesting (origin/client) application. In one example, a request may optionally contain a description and the order in which specific actions are to be performed, and/or the managed objects (MOs) on which such actions are to be applied. Similarly, a response from the actions API controller 200 may contain information about the result of each of these actions, along with specific information about potential failures in executing each specific action, and so forth.

In various examples, a managed object (MO) may be a network element, a component of a network element, a system comprising a plurality of network elements, and application or service provided via one or more network elements, and so forth. In one example, a managed object may be managed through the use of an Open Systems Interconnection (OSI) management protocol. Within the context of one vendor's products, the vendor may have a specific way of exposing configurations using those MOs, and may uniquely define how parameters are part of such MOs. In other words, a managed object may comprise a data structure that organizes configuration management parameters and performance management parameters in a defined way. Thus, MO organization may be different across different vendors' products. However, insofar as vendors are transparent about how the MOs are organized, an actions API controller 200 may interact with such MOs using vendor-specific actions (e.g., vendor 1 actions 222 and/or vendor 2 actions 223 via vendor 1 API 230 and/or vendor 2 API 235).

In one example, actions may be executed in “batches.” In particular, if the requesting application includes a large number of actions and/or MOs where the actions are to be applied (or requests a network management task with large number of actions and/or MOs), the actions may be conveyed to the southbound NMS environment in batches of one or more actions, in order to avoid potential NMS overloading. In one example, the actions API controller 200 may communication with the respective NMSs to identify whether and when the NMSs have capacity or are overloaded, etc. Thus, actions and MOs may be grouped in batches responsive to the capabilities and/or states of the respective NMS. In one example, the actions API controller 200 may send one batch at a time toward a single NMS, and wait for a response from the NMS before proceeding with the next batch (e.g., until all batches have been sent).

To illustrate, a vendor-specific EMS may lack scalability in the sense that if the EMS receives a very large request, such as “configure all cell sites in south Florida” (e.g., affecting hundreds of MOs), the EMS may crash. In this case, the client system/application or the actions API controller 200 may decide how many actions to send to the EMS at one time. For instance, the actions API controller 200 may determine to send 100 at a time, while reserving the remaining pipeline actions in a queue to help ensure that the EMS is not overloaded. It should be noted that the client system/application may optionally specific a batch size, a maximum time to complete all operations, an allowable delay, etc. However, in another example, the client system/application need not be aware, and may allow the actions API controller 200 to solely decide how much to send per batch, when to send/how long wait between batches, etc.

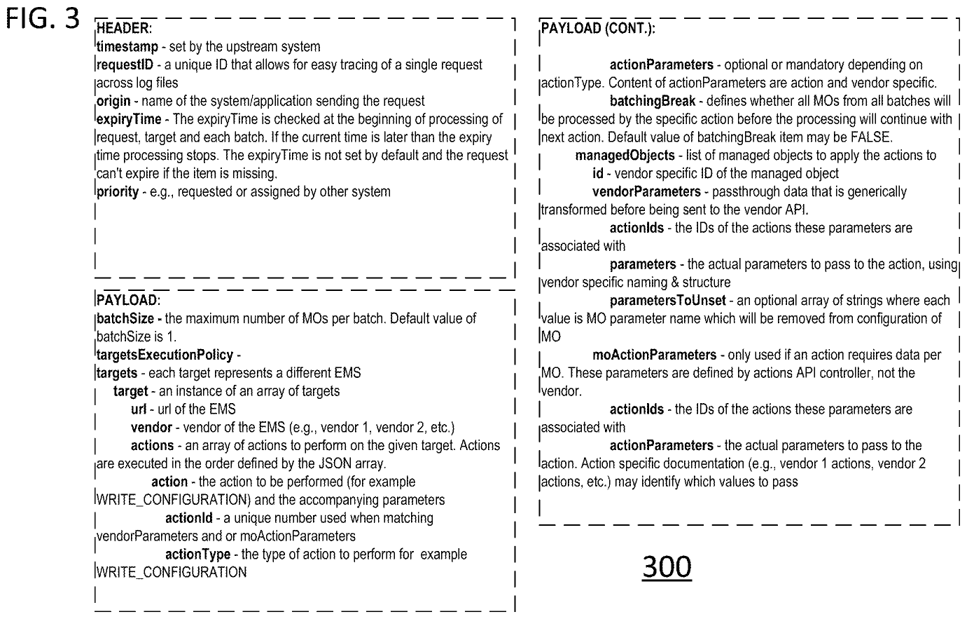

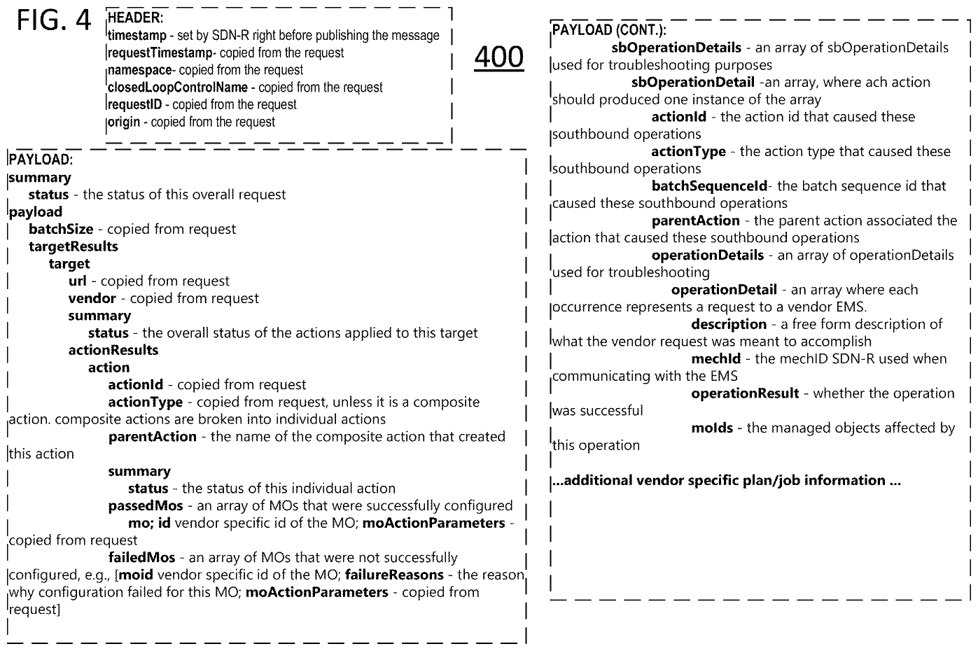

To further aid in understanding the present disclosure, an example format of an actions API request 300 is illustrated in FIG. 3 and an example format of an actions API response is illustrated in FIG. 4. In particular the actions API request 300 may be in a Java Script Object Notation (JSON) format and may have a header and a payload. The header may include high level information, such as the time of the request (timestamp), origin (e.g., the name, identifier (ID), or the like of the requesting application/system), an expiry time, and a priority. For instance, with respect to the expiry time, the requesting application/system may indicate that the request is for a network management task that should be performed within the next 5 minutes, the next 10 minutes, etc. If the time passes before the actions API controller can process the request and instruct an NMS and/or EMS accordingly, then the actions API controller may decline to continue processing the request. In addition, actions that are initiated to an NMS and/or EMS may also include an expiry time to allow these systems to either continue to process or discard certain actions/functions that may be in-queue.

The payload may include a batch size, e.g., the maximum number of MOs per batch. For instance, as mentioned above, a requesting application/system may optionally define this parameter. Alternatively, the actions API controller may determine appropriate batch sizes based upon a stored action pipeline for a network management task (e.g., identified in the action(s) contained in another field of the payload). For instance, the “targets” field may identify one or more EMSs (alternatively NMSs) that may be associated with MOs implicated by the requested management task, the vendor(s) of the EMS(s)/NMS(s) (and hence of the MOs associated therewith), etc. The action(s) may be specified as an array of one or more actions/functions. In one example, an order of actions/operations may be defined in the array entries and/or encoded in the order of entries in the array. Alternatively, or in addition, the “action” field may identify a predefined network management task that may have an associated action/function pipeline defined in a library (e.g., in vendor-independent actions 221 of FIG. 2). In such an example, an actions API controller may match the action in the request to the pipeline of functions, from which the component actions/functions may be identified (and then mapped to vendor-specific actions for the relevant MO(s)). In addition to the foregoing, the payload may also include action parameters, a batching break factor, a list of managed objects (MO) and information thereof, such as MO identifiers, action identifiers (e.g., to associate actions with the MO(s) to which the actions apply), and so forth.

In one example, requesting applications/systems may have knowledge of vendor specific aspects. Thus, additional fields such as moActionParameters, actionIds, and actionParameters may be optionally specified. If omitted, the actions API controller may determine the vendor specific actions and parameters thereof by mapping of vendor-independent actions to respective vendor-specific actions (such as via actions repository 220 of FIG. 2). It should be noted that the example API request 300 is provided for illustrative purposes only and that in other, further, and different examples, an API request may have a different form, such as having one or more additional fields, omitting one or more fields, having fields organized in a different order, having sub-fields in different hierarchies and/or in a non-hierarchical organization, and so forth. Thus, these and other modifications are all contemplated within the scope of the present disclosure.

An example format of an actions API response 400 is illustrated in FIG. 4. In particular the actions API response 400 may be in a JSON format and may have a header and a payload. The header may include high level information, such as the timestamp, origin, request identifier (ID), and so forth. Some or all of the header information may be copied from the request, e.g., such that the response may be matched to the request by the client application/system as well as for recordkeeping associated with the actions API controller, and so forth. The payload may include similar information as the payload of the actions API request, such as the batch size, action(s), and so forth. However, the actions API response 400 may include status information (e.g., in the status field) and action results (which may include passed MOs (those for which one or more actions has/have been successfully executed), and failed MOs (those for which one or more actions has/have failed to execute or did not execute properly)). Additional fields may relate to the actions passed to the NMS(s) and/or EMS(s), such as the action IDs, action types, batch sequence ID, a parent action that may be associated with a particular action (e.g., a sub-action), an operation result (e.g., a result of each action), and so forth. Similar to the above, it should be noted that the example API response 400 is provided for illustrative purposes only and that in other, further, and different examples, an API response may have a different form, such as having one or more additional fields, omitting one or more fields, having fields organized in a different order, having sub-fields in different hierarchies and/or in a non-hierarchical organization, and so forth. Thus, these and other modifications are all contemplated within the scope of the present disclosure.

FIG. 5 illustrates a flowchart of an example method 500 for selecting and executing a pipeline of functions specific to a first vendor and to a network management task based upon network state information. In one example, steps, functions, and/or operations of the method 500 may be performed by a device or system as illustrated in FIG. 1, e.g., ONAP 190, AS 195, or the like, and/or by device or system as illustrated in FIG. 2, such as actions API controller 200. Alternatively, or in addition, the steps, functions and/or operations of the method 500 may be performed by a processing system collectively comprising a plurality of devices as illustrated in FIG. 1 such as the ONAP 190 operating as a distributed system, ONAP 190 in conjunction with one or more NMSs and/or EMSs, AS 195, and so forth. In one example, the steps, functions, or operations of method 500 may be performed by a computing device or system 600, and/or a processing system 602 as described in connection with FIG. 6 below. For instance, the computing device 600 may represent at least a portion of a platform, a server, a system, and so forth, in accordance with the present disclosure. For illustrative purposes, the method 500 is described in greater detail below in connection with an example performed by a processing system. The method 500 begins in step 505 and proceeds to step 510.

At step 510, the processing system (e.g., deployed in a communication network) obtains, from a requesting system, a request for a network management task associated with at least one managed object (MO) in the communication network. The at least one managed object may be a managed object of a first vendor of a plurality of vendors. In addition, the processing system may comprise an application programming interface (API) to process network management task requests associated with managed objects of a plurality of different vendors including the first vendor. In one example, the requesting system may select the network management task from a catalog of network management tasks provided via the processing system. In one example, the request may identify the first vendor. For instance, as noted above in connection with the example of FIG. 3, the request may specifically identify the relevant vendor. Alternatively, or in addition, the first vendor may be identified in the request based upon at least one information field associated with the at least one managed object (e.g., one of the JSON fields in the example of FIG. 3). For instance, in one example, the communication network may only include network elements of a particular type from a single vendor. Alternatively, a managed object name and/or identifier (or a portion thereof) may be uniquely indicative of the vendor (e.g., all MO IDs starting with ABCXYZ may be of vendor 1, while all MO IDs starting with DEFUVW may be of vendor 2). In one example, the network management task may comprise a radio access network data access task (e.g., at least one read operation/action) for a radio access portion of the communication network. In one example, the network management task may comprise a radio access network configuration task (e.g., at least one write operation/action) for the radio access portion of the communication network. In addition, the at least one MO may be associated with at least one network element of the communication network (e.g., at least one RAN component, or the like, core network component(s), VM(s), container(s), VNF(s), layer 3 routers (internal and external (e.g., PE router(s), CE router(s), etc.)), switches, firewalls, border elements, and so forth). It should again be noted that in various examples, the at least one MO may be a network element, a component of a network element, a system comprising a plurality of network elements, and application or service provided via one or more network elements, and so forth.

At step 520, the processing system selects a pipeline of functions associated with the network management task, where the pipeline of functions is specific to the first vendor and to the network management task. In one example, the network management task may be associated with a plurality of pipelines of functions, where each of the plurality of pipelines of functions is specific to a different vendor of the plurality of vendors. Thus, in one example, the processing system may select the pipeline of functions for a particular vendor based upon identities of the MO(s) identified in the request. In one example, the pipeline of functions may include at least one read operation and/or at least one write operation (e.g., to be performed with respect to one or more managed objects). To further illustrate, the pipeline of functions may be associated with the network management task in a catalog/library of network management tasks. Each network management task may comprise one or more actions/functions. Thus, some network management tasks may include a single action/function, while others may include a pipeline of two or more actions/functions, e.g., to be performed in a defined or selected order. In one example, the network management task may be associated with vendor-independent actions/functions, where each of the vendor-independent actions/functions may be further associated with two or more vendor-specific actions/functions (e.g., the same or substantially similar functions, where the respective vendor-specific actions/functions may use different respective vendor APIs). To illustrate, the client system submitting the request may identify the network management task in the request. In addition, the network management task may have an associated vendor-independent pipeline of actions/functions in a repository (e.g., actions repository 220 of FIG. 2, or the like), which may be found by the processing system by performing a look-up in the repository.

At step 530, the processing system gathers network state information relating to the pipeline of functions. For instance, where the request relates to a particular set of one or more MOs, the processing system may obtain current configuration settings/parameters, current and/or recent performance indicators, or the like with respect to the identified MOs. In one example, the network management task may define the relevant MOs and/or the relevant network state information to be collected. In one example, the network state information may be obtained from a data repository storing such information (such as an AAI system, a UDR, or the like). Alternatively, or in addition, the processing system may perform read operations, e.g., via instructions to one or more NMSs and/or EMSs associated with MOs implicated by the request.

At step 540, the processing system executes the pipeline of functions based upon the network state information to perform the network management task. In one example, step 540 may comprise transmitting at least one instruction to a first network management system of the communication network, the first network management system (NMS) associated with the first vendor, and/or to a first element management system (EMS) associated with the first vendor. In this regard, it should be noted that the processing system may comprise an ONAP and/or a component thereof, an OSS and/or a component thereof, a network controller, or the like. To further illustrate, the first NMS may be one of a plurality of NMSs of the communication network, where each of the NMSs is associated with a different vendor of the plurality of vendors. Similarly, the first EMS may be one of a plurality of EMSs of the communication network, where each of the EMSs is associated with a different vendor of the plurality of vendors. It should also be noted the communication network may also have multiple EMSs per vendor that may be associated with and managed by the respective NMSs.

In one example, step 540 may include selecting one or more functions of the pipeline of functions for performance or omission based upon the network state information. For example, the selecting may be in accordance with one or more rules defining when to perform the one or more functions and when to omit the one or more functions. In one example, the rule(s) may be part of the pipeline of functions (e.g., which may be stored in vendor-independent actions 221 within the example actions repository 220 of FIG. 2). In one example, a vendor-independent pipeline (e.g., which may be identified at step 520) may include vendor-independent actions that may be mapped to respective vendor-specific actions/functions in the repository. Thus, the selecting of functions at step 540 may include performing one or more additional look-ups in the repository to identify the vendor-specific actions/functions corresponding to the vendor-independent actions/functions identified in the vendor-independent pipeline.

In one example, step 540 may include transmitting a plurality of instructions to the first NMS or to the first EMS via a vendor-specific API (e.g., a first vendor-specific API, where the processing system may utilize a plurality of different vendor-specific APIs for interacting with NMSs and/or EMSs of different vendors). In one example, each of the instructions may be for a different function of the pipeline of functions. In one example, the plurality of instructions may be transmitted in a defined order according to the pipeline of functions. In addition, in one example, step 540 may include segregating the plurality of instructions into a plurality of batches. For instance, each of the plurality of batches may comprise one or more of the plurality of instructions. In such an example, step 540 may further include transmitting the plurality of batches with delays between batches of the plurality of batches (e.g., from zero to a maximum delay). For example, the processing system may select the delays based upon: a workload of the processing system, a workload of the first NMS and/or the first EMS, a workload of the at least one managed object, and so forth. In this regard, it should be noted that a workload may be based on the number of operations that have not been indicated as completed by the NMS and/or the EMS, the nature of such operations, and so forth. Alternatively, or in addition, the workload may be based upon processor utilization, memory utilization, etc., from which the workload may be inferred/computed.

At step 550, the processing system reports to the requesting system a result of the network management task. For instance, the result may be such as illustrated in the example actions API response 400 of FIG. 4, or the like.

Following step 550, the method 500 ends in step 595. It should be noted that method 500 may be expanded to include additional steps, or may be modified to replace steps with different steps, to combine steps, to omit steps, to perform steps in a different order, and so forth. For instance, in one example, the processing system may repeat one or more steps of the method 500, such as steps 510-550 for additional network management task requests. In one example, the gathering of the network state information of step 530 may be defined as one of the functions in the pipeline of functions. In one example, the method 500 may be expanded or modified to include steps, functions, and/or operations, or other features described above in connection with the example(s) of FIGS. 1-4, or as described elsewhere herein. Thus, these and other modifications are all contemplated within the scope of the present disclosure.

In addition, although not specifically specified, one or more steps, functions, or operations of the method 500 may include a storing, displaying, and/or outputting step as required for a particular application. In other words, any data, records, fields, and/or intermediate results discussed in the method 500 can be stored, displayed and/or outputted either on the device executing the method 500, or to another device, as required for a particular application. Furthermore, steps, blocks, functions, or operations in FIG. 5 that recite a determining operation or involve a decision do not necessarily require that both branches of the determining operation be practiced. In other words, one of the branches of the determining operation can be deemed as an optional step. In addition, one or more steps, blocks, functions, or operations of the above described method 500 may comprise optional steps, or can be combined, separated, and/or performed in a different order from that described above, without departing from the examples of the present disclosure.

FIG. 6 depicts a high-level block diagram of a computing device or processing system specifically programmed to perform the functions described herein. For example, any one or more components or devices illustrated in FIGS. 1 and 2, or described in connection with the examples of FIGS. 3-5 may be implemented as the processing system 600. As depicted in FIG. 6, the processing system 600 comprises one or more hardware processor elements 602 (e.g., a microprocessor, a central processing unit (CPU) and the like), a memory 604, (e.g., random access memory (RAM), read only memory (ROM), a disk drive, an optical drive, a magnetic drive, and/or a Universal Serial Bus (USB) drive), a module 605 for selecting and executing a pipeline of functions specific to a first vendor and to a network management task based upon network state information, and various input/output devices 606, e.g., a camera, a video camera, storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like).

Although only one processor element is shown, it should be noted that the computing device may employ a plurality of processor elements. Furthermore, although only one computing device is shown in FIG. 6, if the method(s) as discussed above is implemented in a distributed or parallel manner for a particular illustrative example, i.e., the steps of the above method(s) or the entire method(s) are implemented across multiple or parallel computing devices, e.g., a processing system, then the computing device of FIG. 6 is intended to represent each of those multiple computing devices. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented. The hardware processor 602 can also be configured or programmed to cause other devices to perform one or more operations as discussed above. In other words, the hardware processor 602 may serve the function of a central controller directing other devices to perform the one or more operations as discussed above.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computing device, or any other hardware equivalents, e.g., computer readable instructions pertaining to the method(s) discussed above can be used to configure a hardware processor to perform the steps, functions and/or operations of the above disclosed method(s). In one example, instructions and data for the present module or process 605 for selecting and executing a pipeline of functions specific to a first vendor and to a network management task based upon network state information (e.g., a software program comprising computer-executable instructions) can be loaded into memory 604 and executed by hardware processor element 602 to implement the steps, functions or operations as discussed above in connection with the example method(s). Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 605 for selecting and executing a pipeline of functions specific to a first vendor and to a network management task based upon network state information (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various embodiments have been described above, it should be understood that they have been presented by way of example only, and not limitation. Thus, the breadth and scope of a preferred embodiment should not be limited by any of the above-described example embodiments, but should be defined only in accordance with the following claims and their equivalents.

What is claimed is:

1. A method comprising:
obtaining, by a processing system including at least one processor deployed in a communication network from a requesting system, a request for a network management task associated with at least one managed object in the communication network, wherein the at least one managed object is of a first vendor of a plurality of vendors, wherein the processing system comprises an application programming interface to process network management task requests associated with managed objects of the plurality of vendors including the first vendor;
selecting, by the processing system, a pipeline of functions associated with the network management task, wherein the pipeline of functions is specific to the first vendor and to the network management task;
gathering, by the processing system, network state information relating to the pipeline of functions;
executing, by the processing system, the pipeline of functions based upon the network state information to perform the network management task; and
reporting, by the processing system, to the requesting system a result of the network management task.

2. The method of claim 1, wherein the network management task comprises:
a radio access network configuration task for a radio access portion of the communication network; or
a radio access network data access task for a radio access portion of the communication network.

3. The method of claim 1, wherein the pipeline of functions includes at least one of:
at least one read operation; or
at least one write operation.

4. The method of claim 1, wherein the executing the pipeline of functions comprises transmitting at least one instruction to:
a first network management system of the communication network, the first network management system associated with the first vendor; or
a first element management system associated with the first vendor.

5. The method of claim 4, wherein the first network management system is one of a plurality of network management systems of the communication network, wherein each of the plurality of network management systems is associated with a different vendor of the plurality of vendors.

6. The method of claim 4, wherein the first element management system is one of a plurality of element management systems of the communication network, wherein each of the plurality of element management systems is associated with a different vendor of the plurality of vendors.

7. The method of claim 4, wherein the executing of the pipeline of functions comprises:
transmitting a plurality of instructions to the first network management system or the first element management system via a vendor-specific application programming interface.

8. The method of claim 7, wherein the plurality of instructions is transmitted in a defined order according to the pipeline of functions.

9. The method of claim 7, wherein each of the plurality of instructions is for a different function of the pipeline of functions.

10. The method of claim 9, wherein the transmitting the plurality of instructions comprises:
segregating the plurality of instructions into a plurality of batches, each of the plurality of batches comprising one or more of the plurality of instructions; and
transmitting the plurality of batches with delays between batches of the plurality of batches.

11. The method of claim 10, wherein the delays are based upon at least one of:
a workload of the processing system;
a workload of the first network management system or the first element management system; or
a workload of the at least one managed object.

12. The method of claim 1, wherein the request identifies the first vendor.

13. The method of claim 1, wherein the first vendor is identified from the request based on at least an information field associated with the at least one managed object.

14. The method of claim 1, wherein the executing of the pipeline of functions based upon the network state information comprises selecting one or more functions of the pipeline of functions for performance or omission based upon the network state information.

15. The method of claim 14, wherein the selecting is in accordance with one or more rules defining when to perform the one or more functions and when to omit the one or more functions.

16. The method of claim 1, wherein the requesting system selects the network management task from a catalog of network management tasks provided via the processing system.

17. The method of claim 16, wherein the network management task is associated with a plurality of pipelines of functions, wherein each of the plurality of pipelines of functions is specific to a different vendor of the plurality of vendors.

18. The method of claim 1, wherein the at least one managed object is associated with at least one network element of the communication network.

19. A non-transitory computer-readable medium storing instructions which, when executed by a processing system including at least one processor deployed in a communication network, cause the processing system to perform operations, the operations comprising:
obtaining, from a requesting system, a request for a network management task associated with at least one managed object in the communication network, wherein the at least one managed object is of a first vendor of a plurality of vendors, wherein the processing system comprises an application programming interface to process network management task requests associated with managed objects of the plurality of vendors including the first vendor;
selecting a pipeline of functions associated with the network management task, wherein the pipeline of functions is specific to the first vendor and to the network management task;
gathering network state information relating to the pipeline of functions;
executing the pipeline of functions based upon the network state information to perform the network management task; and
reporting to the requesting system a result of the network management task.

20. An apparatus comprising:
a processing system including at least one processor; and
a computer-readable medium storing instructions which, when executed by the processing system, cause the processing system to perform operations, the operations comprising:
obtaining, from a requesting system, a request for a network management task associated with at least one managed object in the communication network, wherein the at least one managed object is of a first vendor of a plurality of vendors, wherein the processing system comprises an application programming interface to process network management task requests associated with managed objects of the plurality of vendors including the first vendor;
selecting a pipeline of functions associated with the network management task, wherein the pipeline of functions is specific to the first vendor and to the network management task;
gathering network state information relating to the pipeline of functions;
executing the pipeline of functions based upon the network state information to perform the network management task; and
reporting to the requesting system a result of the network management task.
